(19) United States
(12) Patent Application Publication
(10) Pub. No.: US 2017/0077466 A1
(43) Pub. Date: Mar. 16, 2017

(54) HIGH VOLTAGE BATTERY SUBMODULE

(71) Applicant: HYUNDAI MOBIS Co., Ltd., Yongin-si (KR)

(72) Inventors: Chang Youl CHOI, Yongin-si (KR); Yun Su PARK, Yongin-si (KR); Ho Young PARK, Yongin-si (KR)

(73) Assignee: HYUNDAI MOBIS Co., Ltd., Yongin-si (KR)

(21) Appl. No.: 15/179,633

(22) Filed: Jun. 10, 2016

(30) Foreign Application Priority Data
Sep. 16, 2015 (KR) 10-2015-0130919

(51) Int. Cl. H01M 2/10; H01M 10/613; H01M 10/48; H01M 10/6561; H01M 2/20; H01M 2/04; H01M 10/625

(52) U.S. Cl. CPC H01M 2/1077; H01M 2/043; H01M 10/613; H01M 10/625; H01M 10/6561; H01M 2/206; H01M 10/48; H01M 2220/20

(57) ABSTRACT

Provided are a high voltage battery submodule capable of protecting a high voltage battery cell from external force and preventing a contact failure from occurring between an electrode tab and a voltage sensing terminal. A frame includes an upper frame which accommodates a pair of high voltage battery cells therein, a plurality of intermediate frames which are disposed under the upper frame and accommodate a pair of high voltage battery cells therein, and a lower frame which are disposed under a lowermost intermediate frame and accommodate a pair of high voltage battery cells, and a cell cover is disposed on only any one of an upper side or a lower side of each of a plurality of high voltage battery cells in the frame.

### CROSS-REFERENCE TO RELATED APPLICATION

This application claims priority to and the benefit of Korean Patent Application No. 10-2015-0130919, filed on Sep. 16, 2015, the disclosure of which is incorporated herein by reference in its entirety.

### BACKGROUND

1. Field

The present disclosure relates to a high voltage battery submodule.

2. Discussion of Related Technology

Generally, a hybrid electric vehicle, a fuel cell vehicle, and an electric vehicle are all driven by electric motors, and a high voltage battery that provides driving power to an electric motor is essentially mounted therein.

The high voltage battery is configured to supply required power while repeating charge and discharge during driving of a vehicle.

### SUMMARY

The present disclosure is directed to a high voltage battery submodule capable of protecting a high voltage battery cell using an aluminum laminate sheet as an external member from external force and preventing a contact failure from occurring between an electrode tab and a voltage sensing terminal.

According to an aspect of the present invention, there is provided a high voltage battery submodule which is installed in a high voltage battery system, the submodule including a plurality of high voltage battery cells which store power to be supplied to the high voltage battery system, are stacked in a vertical direction to be in area contact with each other, and have electrode tabs extending from both sides among edge surfaces thereof in a horizontal direction, a frame formed in a rectangular ring shape to be in close contact with the edge surfaces of the high voltage battery cells and having electrode tab mounting grooves in which the electrode tabs are mountable at positions corresponding to the electrode tabs, formed in an inner side surface, and a cell cover disposed on or under a pair of high voltage battery cells which are in area contact with each other in the frame, wherein the frame includes an upper frame which accommodates a pair of high voltage battery cells therein, a plurality of intermediate frames which are disposed under the upper frame and accommodate a pair of high voltage battery cells therein, and a lower frame which are disposed under a lowermost intermediate frame and accommodate a pair of high voltage battery cells, and the cell cover is disposed on only any one of an upper side or a lower side of each of a plurality of high voltage battery cells in the frame.

The cell cover may include a base plate disposed on an upper surface or a lower surface of the high voltage battery cell, and a plurality of flow path protrusions which are formed on the base plate, spaced apart from each other in the horizontal direction, and protrudes in the vertical direction.

Cell covers disposed in the intermediate frames, in which flow path protrusions which protrude from base plates face each other, may be disposed as a pair so that a flow path in which a gas for cooling the high voltage battery cells flows is formed between the flow path protrusions disposed to be spaced apart from each other.

Flow path holes in which a gas for cooling heat generated from the high voltage battery cell flows may be formed in both side surfaces of the intermediate frames along a longitudinal direction.

Each of the electrode tabs may include a first electrode tab including a first cell extending portion which extends from an edge surface of the high voltage battery cell in the horizontal direction and a first bent portion bent from the first cell extending portion in the vertical direction, and a second electrode tab including a second cell extending portion which extends from a surface in an opposite direction to the first electrode tab, among the edge surfaces of the high voltage battery cell, in the horizontal direction, a second bent portion bent from the second cell extending portion in the vertical direction, and a bent extending portion which extends from the second bent portion in the horizontal direction, wherein the second electrode tabs of the electrode tabs are symmetrically disposed in the vertical direction based on the horizontal direction between the pair of high voltage battery cells so that the bent extending portions of the second electrode tabs extend respectively from the edges surfaces of the pair of high voltage battery cells which are in area contact with each other and are in area contact with each other.

The electrode tab mounting grooves may include a first mounting groove which is formed at a position corresponding to the first electrode tab in edges of each of the upper frame, the intermediate frames, and the lower frame to have the same width as the first electrode tab, in which the first electrode tab is mounted, is opened to be in communication with the outside, and exposes the first bent portion to the outside, and a second mounting groove including a bent supporting portion which protrudes from a bottom surface of each of the intermediate frames and the lower frame in the vertical direction on the opposite edges of each of the intermediate frames and the lower frame to the first mounting groove and to support the second bent portion, a bent extending and mounting portion which extends from the bent supporting portion in the horizontal direction and in which the bent extending portion is mounted, and a sealing portion which protrudes from the bent extending and mounting portion in the vertical direction and to seal the second electrode tab.

A voltage sensing terminal which senses a voltage of the high voltage battery cell may be disposed on a lower surface of the bent extending portion.

A plurality of sensing terminal protrusions may be formed on an upper surface of the voltage sensing terminal to be pressed into the lower surface of the bent extending portion.

An electrode tab pressing protrusion may be formed at a position corresponding to the second mounting groove on a lower surface of each of the upper frame and the intermediate frames to have the same width as the second mounting groove, and may protrude so that a lower surface of the bent extending portion and the voltage sensing terminal are pressed into each other by pressing the bent extending portion.

When the plurality of high voltage battery cells are stacked in the frame, a bending force portion may be formed between the second cell extending portion and the second bent portion so that the electrically connected bent extending portions are pressed into each other by applying an elastic force in a direction in which the electrically connected bent extending portions face each other.

When the plurality of high voltage battery cells are installed to be stacked in the upper frame, the intermediate frames, and the lower frame, the first electrode tabs of the electrode tabs may be connected in a zigzag form so as to have a structure in which a lowermost first electrode tab and an uppermost first electrode tab are connected to each other.

### BRIEF DESCRIPTION OF THE DRAWINGS

The above and other features and advantages of the present invention will become more apparent to those of ordinary skill in the art by describing in detail embodiments thereof with reference to the accompanying drawings, in which:

FIG. 1 is a perspective view illustrating a high voltage battery submodule according to an embodiment of the present invention;

FIG. 2 is an exploded perspective view illustrating a high voltage battery cell of the high voltage battery submodule illustrated in FIG. 1;

FIG. 3 is an exploded perspective view illustrating a frame of the high voltage battery submodule illustrated in FIG. 1;

FIG. 4 is a perspective view illustrating a cell cover of the high voltage battery submodule illustrated in FIG. 1;

FIG. 5 is a cross-sectional view taken along line A-A′ illustrated in FIG. 1; and

FIG. 6 is a flowchart illustrating a combining sequence of a high voltage battery submodule according to an embodiment of the present invention.

### DETAILED DESCRIPTION OF EMBODIMENTS

Advantages and features of the present invention and methods of achieving the same will be clearly understood with reference to the accompanying drawings and the following detailed embodiments. However the present invention is not limited to the embodiments to be disclosed, but may be implemented in various different forms. The embodiments are provided in order to fully explain the present invention and fully explain the scope of the present invention for those skilled in the art. The scope of the present invention is defined by the appended claims. Meanwhile, the terms used herein are provided to only describe embodiments of the present invention and not for purposes of limitation. Unless the context clearly indicates otherwise, the singular forms include the plural forms. It will be understood that the terms “comprise” or “comprising” when used herein, specify some stated components, steps, operations and/or elements, but do not preclude the presence or addition of one or more other components, steps, operations and/or elements.

A high voltage battery typically includes a plurality of battery modules. Further, each of the plurality of battery modules includes a plurality of battery submodules, and each of the plurality of battery submodules includes a plurality of high voltage battery cells. The high voltage battery cells configured in multiple cells as described above are combined by an upper housing and a lower housing, which respectively support an upper portion and a lower portion of the high voltage battery cell.

As the plurality of high voltage battery cells are inserted into the lower housing to be stacked face-to-face with each other, the battery submodule is formed by fitting and assembling the upper housing on the upper portion of the high voltage battery cells.

The high voltage battery cells may be manufactured in various types. Specifically, among the various types of high voltage battery cells, a pouch-type high voltage battery cell that is recently widely used has a form that can be easily bent using a flexible aluminum laminate sheet as an external member.

Due to advantages such as a light weight, low cost, and the like, interest in the pouch-type high voltage battery cell has been increased recently. However, since the pouch-type high voltage battery cell may be easily bent, the pouch-type high voltage battery cell may be easily damaged when force is applied from the outside. Thus, there is a risk such as the leakage of an electrolyte inside the high voltage battery cell, gas spurting, or the like.

Further, since the battery submodule is formed by stacking the plurality of pouch-type high voltage battery cells, adjacent high voltage battery cells are also directly damaged when the leakage of the electrolyte inside the high voltage battery cells, the gas spurting, or a gas explosion occurs.

In addition, since the high voltage battery has a structure in which the plurality of high voltage battery cells are combined, some high voltage battery cells may cause safety issues and operating efficiency due to over-voltage, over-current, and over-heating. Therefore, there may be needs for a means for detecting these high voltage battery cells.

Thus, in a high voltage battery, a voltage sensor or the like is connected to the high voltage battery cells and checks and controls an operating status thereof in real time or at predetermined time intervals.

In this case, as the high voltage battery is used as a power source of the vehicle, the detection means should be able to stably maintain a connection state even when a strong impact or a vibration is applied thereto.

Typically, in the high voltage battery, voltage sensing terminals, which are connected to a voltage sensor and a printed circuit board (PCB), are in contact with electrode tabs installed on side surfaces of the high voltage battery cell through welding.

Since the electrode tabs and the voltage sensing terminals are combined with each other through welding, the high voltage battery cells are repeatedly expanded and contracted while charging or discharging, and welded portions are separated. Therefore, a contact failure may occur between the electrode tab and the voltage sensing terminal. Thus, heat may become worse during operation of the battery and fire or an explosion may occur, which may cause safety issues.

Because of the above-described reasons, an aluminum laminate sheet is used as an external member in the corresponding field. Therefore, a method of preventing the high voltage battery cells from being damaged by being bent easily and preventing the contact failure from occurring by separating the electrode tab and the voltage sensing terminal is being sought, but so far, satisfactory results are not being obtained.

Hereinafter, embodiments of the invention will be described in detail with reference to the accompanying drawings.

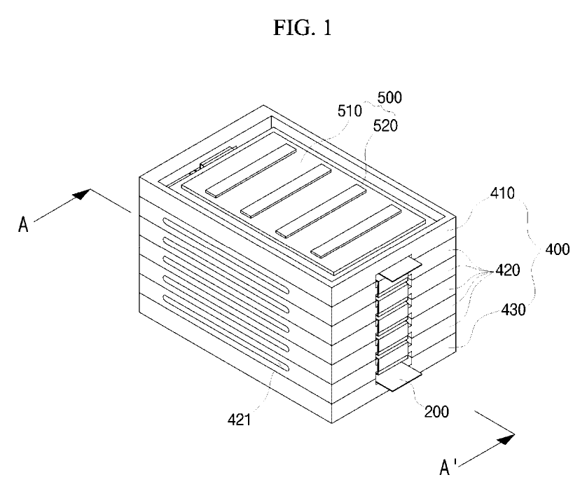

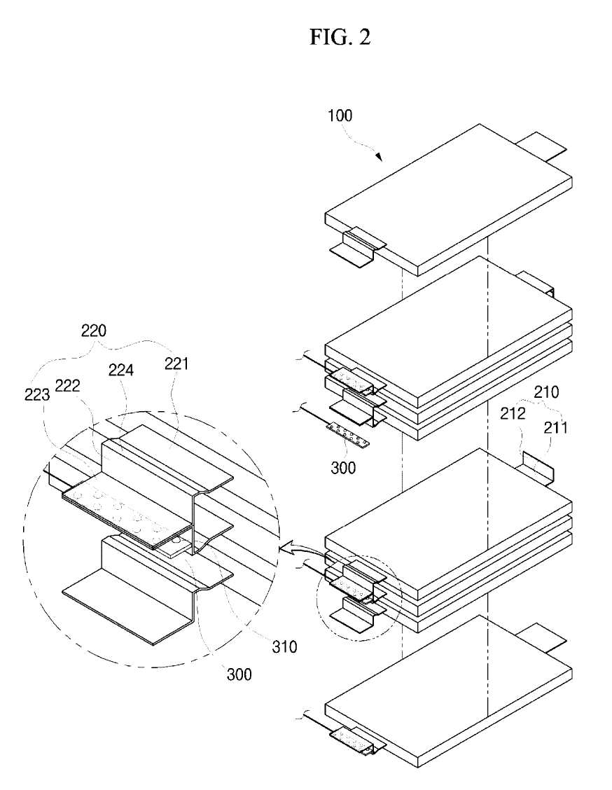

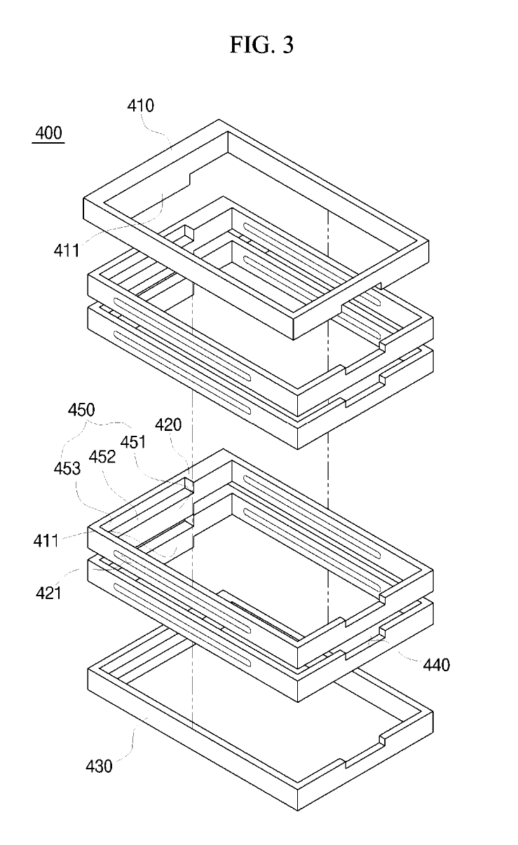

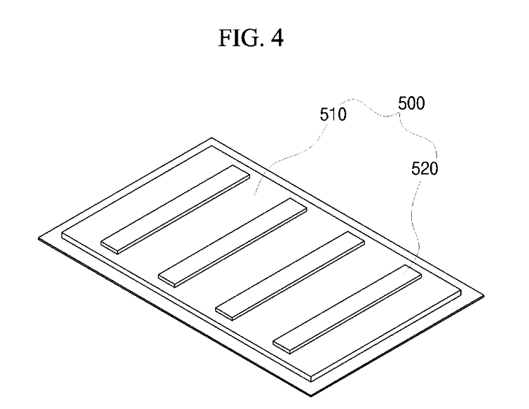

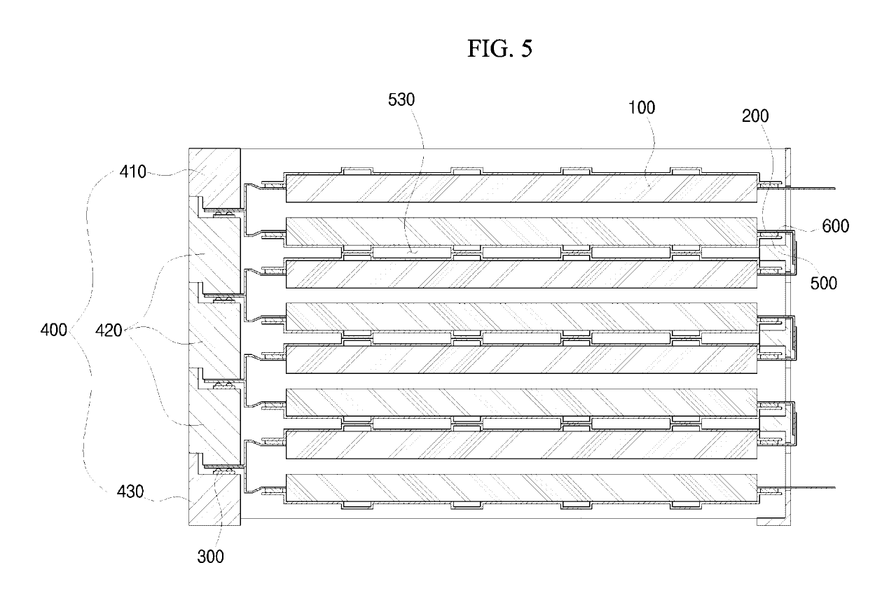

FIG. 1 is a perspective view illustrating a high voltage battery submodule according to an embodiment of the present invention, FIG. 2 is an exploded perspective view illustrating a high voltage battery cell of the high voltage battery submodule illustrated in FIG. 1, FIG. 3 is an exploded perspective view illustrating a frame of the high voltage battery submodule illustrated in FIG. 1, FIG. 4 is a perspective view illustrating a cell cover of the high voltage battery submodule illustrated in FIG. 1, and FIG. 5 is a cross-sectional view taken along line A-A′ illustrated in FIG. 1.

Hereinafter, the high voltage battery submodule according to the embodiment of the present invention will be described.

Referring to FIGS. 1 to 5, the high voltage battery submodule according to the present embodiment includes high voltage battery cells 100, voltage sensing terminals 300, frames 400, cell covers 500, and cell cover insulating portions 600.

The high voltage battery cells 100 store power to be supplied to a high voltage battery system, and the plurality of high voltage battery cells 100 are stacked in a vertical direction to be in area contact with each other.

The plurality of high voltage battery cells 100, which constitute a battery submodule, may be manufactured in various types. In the embodiment of the present invention, the high voltage battery cells 100 are formed in a pouch type.

As the high voltage battery cells 100 are formed in the pouch type, a weight of a battery pack may be reduced.

Electrode tabs 200 are formed at both edge surfaces of the high voltage battery cell 100.

The electrode tabs 200, which include negative electrode terminals and positive electrode terminals, extend from the both edge surfaces of the high voltage battery cell 100 in a horizontal direction.

Each of the electrode tabs 200 includes a first electrode tab 210 and a second electrode tab 220.

The first electrode tab 210 extends from a surface of any one side, among the edge surfaces of the high voltage battery cell 100, in the horizontal direction.

The first electrode tab 210 includes a first cell extending portion 211 configured to extend from the edge surface of the high voltage battery cell 100 in the horizontal direction, and a first bent portion 212 bent from the first cell extending portion 211 in the vertical direction.

In embodiments, the first electrode tab 210 is formed to have a right angle cross sectional shape.

Meanwhile, a first electrode tab 210 formed on an uppermost high voltage battery cell 100 and a first electrode tab 210 formed on a lowermost high voltage battery cell 100, among the plurality of high voltage battery cells 100 which are stacked in the vertical direction, are formed to have a linear cross sectional shape extending in the horizontal direction.

These first electrode tabs 210 formed in the linear shape are electrically connected to a busbar.

Further, a first electrode tab 210 having the right angle cross sectional shape is formed on a high voltage battery cell 100 which is disposed right under the uppermost high voltage battery cell 100, in embodiments, on a second high voltage battery cell 100.

In the first electrode tab 210 formed on the second high voltage battery cell 100, a first bent portion 212 is bent downward from a first cell extending portion 211.

Next, a first bent portion 212 of a first electrode tab 210 formed on a high voltage battery cell 100 disposed right under the second high voltage battery cell 100, in embodiments on a third high voltage battery cell 100, is bent upward from a first cell extending portion 211.

Therefore, the first bent portion 212 formed on the second high voltage battery cell 100 and the first bent portion 212 formed on the third high voltage battery cell 100 overlap each other in the vertical direction.

Thus, the first bent portion 212 formed on the second high voltage battery cell 100 and the first bent portion 212 formed on the third high voltage battery cell 100 are electrically connected to be in area contact with each other.

Even-numbered high voltage battery cells 100 disposed on top in this form and odd-numbered high voltage battery cells 100 disposed close to bottoms of the even-numbered high voltage battery cells 100 are alternately stacked downward, and the first bent portions 212 thereof are electrically connected to be in area contact with each other.

The second electrode tabs 220 extend from a surface opposite to a surface on which a first electrode tab 210 is formed, among the edge surfaces of the high voltage battery cell 100, in the horizontal direction.

The second electrode tab 220 includes a second cell extending portion 221 configured to extend from an edge surface of the high voltage battery cell 100 in the horizontal direction, a second bent portion 222 bent from the second cell extending portion 221 in the vertical direction, a bent extending portion 223 configured to extend from the second bent portion 222 in the horizontal direction, and a bending force portion 224 formed between the second cell extending portion 221 and the second bent portion 222

In embodiments, the second electrode tab 220 is formed in a shape bent in multiple stages.

The second electrode tab 220 is formed on a side surface of a first high voltage battery cell 100 formed on an uppermost end.

In the second electrode tab 220 formed on the first high voltage battery cell 100, the second bent portion 222 is bent downward from the second cell extending portion 221.

Further, a second bent portion 222 of a second electrode tab 220 formed on the high voltage battery cell 100 disposed right under the first high voltage battery cell 100, in embodiments, on the second high voltage battery cell 100, is bent upward from the second cell extending portion 221.

Therefore, a bent extending portion 223 formed at the first high voltage battery cell 100 and a bent extending portion 223 formed at the second high voltage battery cell 100 are in area contact with each other.

Thus, the bent extending portion 223 formed on the first high voltage battery cell 100 and the bent extending portion 223 formed on the second high voltage battery cell 100 are electrically connected to be in area contact with each other.

In this manner, the odd-numbered high voltage battery cells 100 disposed on top and the even-numbered high voltage battery cells 100 disposed close to a bottoms of the odd-numbered high voltage battery cells 100 are alternately stacked downward, and the bent extending portions 223 thereof are electrically connected to be in area contact with each other.

Therefore, when the high voltage battery cells 100 of the present embodiment are installed to be stacked inside the frames 400, the high voltage battery cells 100 are stacked to be connected to each other in a zigzag form so as to have a structure in which a lowermost first electrode tab 210 and an uppermost first electrode tab 210 are connected to each other.

The bending force portion 224, which is preferably a portion having a principle such as a leaf spring, is formed between the second cell extending portion 221 and the second bent portion 222.

When the plurality of high voltage battery cells 100 are stacked in the frames 400, the bending force portion 224 applies an elastic force in a direction in which the electrically connected bent extending portions 223 face each other.

Thus, the bent extending portions 223 are pressed into each other to be electrically connected to each other.

Thus, since the bending force portions 224 firmly press the bent extending portions 223, which are formed at the odd-numbered high voltage battery cells 100 and the even-numbered high voltage battery cells 100 to be in area contact with each other, a contact failure may be prevented from occurring even during repeated expansion and contraction of the high voltage battery cells 100 while charging or discharging the battery submodule.

Each of the voltage sensing terminals 300, which is formed as a conductor having a bar shape and disposed on a lower surface of the bent extending portion 223, senses a voltage of the high voltage battery cell 100.

The voltage sensing terminals 300 are electrically connected to a battery management system (BMS) which determines the remaining capacity of the high voltage battery cells 100 and charging necessity, and transfer voltages sensed from the high voltage battery cells 100 to the BMS.

In the voltage sensing terminal 300, sensing terminal protrusions 310 protrude in a direction facing the bent extending portion 223.

The sensing terminal protrusions 310, which are formed on the voltage sensing terminal 300, are configured to firmly press the voltage sensing terminal 300 and the bent extending portion 223.

Thus, a contact failure may be prevented from occurring between the bent extending portion 223 and the voltage sensing terminal 300 even during repeated expansion and contraction of the high voltage battery cells 100 while charging or discharging the battery submodule.

Further, unlike a conventional case in which an electrode tab and a voltage sensing terminal are in contact with each other through a soldering method, in the embodiment of the present invention, the electrode tab 200 and the voltage sensing terminal 300 are physically pressed into each other, and thus an assembly time of the high voltage battery submodule may be effectively reduced.

Referring to FIG. 3, the frames 400 are formed of an insulating material such as plastic.

As the frames 400 are formed of the insulating material, electricity between the high voltage battery cells 100 may be insulated from each other, thereby decreasing a weight of the frame 400 and improving durability due to a characteristic of the material.

The frames 400 are formed in a rectangular ring shape to be in close contact with the edge surfaces of the high voltage battery cell 100.

The frames 400 include an upper frame 410, intermediate frames 420, and a lower frame 430.

The upper frame 410, which is an uppermost frame 400 of the plurality of frames 400, accommodates a pair of high voltage battery cells 100 therein.

Each of the intermediate frames 420 accommodates a pair of the high voltage battery cells 100 therein, and the plurality of intermediate frames 420 are stacked under the upper frame 410 in the vertical direction to be in area contact with each other.

The intermediate frames 420 configured in multiple frames are preferably stacked in a number corresponding to a type of vehicle or a voltage required for the vehicle.

Flow path holes 421 are formed in both side surfaces of the intermediate frame 420.

The flow path holes 421, which are holes through which a gas flows into the intermediate frame 420 to cool the high voltage battery cell 100, are formed in the side surfaces of the intermediate frame 420 in an elongated hole shape.

Thus, heat generated from the pair of high voltage battery cells 100 disposed in each of the intermediate frames 420 configured in multiple frames may be effectively cooled.

Meanwhile, an electrode tab pressing protrusion 411 is formed in a lower surface of each of the upper frame 410 and the intermediate frame 420.

The electrode tab pressing protrusion 411 is formed at a position corresponding to a second electrode tab mounting groove 450 to be described below in the lower surface of each of the upper frame 410 and the intermediate frame 420 to have the same width as the second electrode tab mounting groove 450.

The electrode tab pressing protrusion 411 firmly presses the bent extending portion 223 and the voltage sensing terminal 300 by pressing the bent extending portion 223 mounted on the second electrode tab mounting groove 450 when the high voltage battery cells 100 are stacked in the upper frame 410, the intermediate frames 420, and the lower frame 430.

Thus, the contact failure may be prevented from occurring between the bent extending portion 223 and the voltage sensing terminal 300 even during repeated expansion and contraction of the high voltage battery cells 100 while charging or discharging the battery submodule.

The lower frame 430 accommodates a pair of high voltage battery cells 100 therein.

The lower frame 430, which is a lowermost frame 400 of the plurality of frames 400, is disposed under a lowermost intermediate frame 420 of the plurality of intermediate frames 420.

Meanwhile, a first electrode tab mounting groove 440 and a second electrode tab mounting groove 450 are formed in each of the upper frame 410, the intermediate frames 420, and the lower frame 430.

The first electrode tab mounting groove 440 is formed at a side in which the first electrode tab 210 is disposed in each of the upper frame 410, the intermediate frames 420, and the lower frame 430.

The first electrode tab mounting groove 440 is formed at a position corresponding to the first electrode tab 210 in edges of each of the upper frame 410, the intermediate frames 420, and the lower frame 430 to have the same width as the first electrode tab 210.

The first electrode tab mounting groove 440 in which the first electrode tab 210 is mounted thereon, is opened to be in communication with the outside, and exposes the first bent portion 212 to the outside of each of the upper frame 410 and the intermediate frames 420 and the lower frame 430.

The first electrode tab mounting groove 440 is opened so that the inside of each of the upper frame 410, the intermediate frames 420, and the lower frame 430 are in communication with the outside, and thus an outer surface of the first bent portion 212 is exposed to the outside of the frame 400 when the first electrode tab 210 is mounted.

More specifically, the first electrode tab mounting groove 440 exposes the first bent portion 212, which is vertically bent downward from the first cell extending portion 211 formed on the side surface of the second high voltage battery cell 100, between the upper frame 410 and an uppermost intermediate frame 420 of the plurality of intermediate frames 420.

Further, the first electrode tab mounting groove 440 exposes the first bent portion 212, which is vertically bent upward from the first cell extending portion 211 formed on the side surface of the third high voltage battery cell 100, between the uppermost intermediate frame 420 of the plurality of intermediate frames 420 and an intermediate frame 420 disposed right under the intermediate frame 420.

Therefore, the first bent portions 212, which are formed at the second high voltage battery cell 100 and the third high voltage battery cell 100, are exposed from the first electrode tab mounting groove 440, and thus are electrically connected to be easily in contact with each other.

Further, the first electrode tab mounting groove 440 formed in the lower frame 430 has a vertically symmetric shape and structure with the upper frame 410, and thus the first bent portion 212 is exposed to the outside through the first electrode tab mounting groove 440 formed between the lower frame 430 and the lowermost intermediate frame 420 of the plurality of intermediate frames 420.

In embodiments, the first electrode tab mounting groove 440 exposes the first electrode tabs 210 configured to extend from the high voltage battery cells 100 to the outside, and thus the first bent portions 212 may be easily electrically connected to each other.

The second electrode tab mounting groove 450 is formed at a corresponding position in the edges of the intermediate frames 420 and the lower frame 430 to have the same width as the first electrode tab 210.

The second electrode tab mounting groove 450 includes a bent supporting portion 451, a bent extending and mounting portion 452, and a sealing portion 453.

The bent supporting portion 451 protrudes from a bottom surface of the edge opposite to the first electrode tab mounting groove 440 in the vertical direction in the intermediate frames 420 and the lower frame 430.

The bent supporting portion 451 protrudes in the vertical direction so that the second bent portion 222 of the second electrode tab 220 is not bent.

The bent extending and mounting portion 452 extends from the bent supporting portion 451 in the horizontal direction.

The bent extending and mounting portion 452 supports the bent extending portion 223 so that the bent extending portion 223 is not bent due to a pressure caused by the stacking of the plurality of high voltage battery cells 100 when the plurality of high voltage battery cells 100 are stacked in the vertical direction and the bent extending portions 223 are in contact with each other.

The sealing portion 453 protrudes from the bent extending and mounting portion 452 in the vertical direction to seal the second electrode tab 220.

Thus, the sealing portion 453 prevents external foreign matter from entering the inside of the frames 400 to protect the second electrode tab 220 from the external foreign matter.

Referring to FIGS. 4 and 5, the cell covers 500 are disposed on or under a pair of high voltage battery cells 100 which are in area contact with each other in the frame 400.

More specifically, the cell cover 500 disposed in the upper frame 410 is disposed on an upper surface of an upper high voltage battery cell 100 of the pair of high voltage battery cells 100, and the cell cover 500 disposed in the lower frame 430 is disposed on a lower surface of a lower high voltage battery cells 100 of the pair of high voltage battery cells 100.

In embodiments, the cell cover 500 is disposed on only any one of an upper side or a lower side of the high voltage battery cells 100 disposed in the upper frame 410 and the lower frame 430.

Thus, the cell cover 500 disposed at the upper side of the upper frame 410 may protect the high voltage battery cell 100 disposed in the upper frame 410 from external force.

Further, the cell cover 500 disposed at the lower side of the lower frame 430 may protect the high voltage battery cell 100 disposed in the lower frame 430 from the external force.

Meanwhile, the cell covers 500 disposed in the intermediate frames 420 are formed in pairs of cell covers 500, and are disposed between the plurality of high voltage battery cells 100.

Each of the cell covers 500 includes a base plate 510 and flow path protrusions 520.

The base plate 510 is formed in an area greater than the high voltage battery cell 100 and smaller than an inner side surface of the frame 400.

The base plate 510 is disposed on the upper surface of or the lower surface of the high voltage battery cell 100 to cover the high voltage battery cell 100.

The plurality of flow path protrusions 520 are formed on an upper surface of or a lower surface of the base plate 510, are spaced apart from each other in the horizontal direction, and protrude from the upper surface of or the lower surface of the base plate 510 in the vertical direction.

Meanwhile, the cell covers 500 disposed in the intermediate frames 420, in which the flow path protrusions 520 protruding from the base plates 510 face each other, are disposed in pairs.

Thus, cooling flow paths 530, in which a gas for cooling the high voltage battery cell 100 flows between the flow path protrusions 520 disposed spaced apart from each other, are formed in the intermediate frames 420.

Therefore, the gas for cooling the high voltage battery cells 100 flows in the cooling flow paths 530 formed on the cell cover 500, and thus heat generated from the high voltage battery cells 100 may be effectively cooled.

The cell cover insulating portions 600, which are formed of nonconductors, block electrical connections between the electrode tabs 200 and the cell cover 500 which are formed of conductors.

To this end, each of the cell cover insulating portions 600 is disposed between the cell cover 500 and the electrode tab 200.

Thus, the cell cover insulating portions 600 may effectively block the electrical connections between the electrode tabs 200 and the cell cover 500.

Hereinafter, an assembly sequence of the high voltage battery submodule according to the embodiment of the present invention will be described.

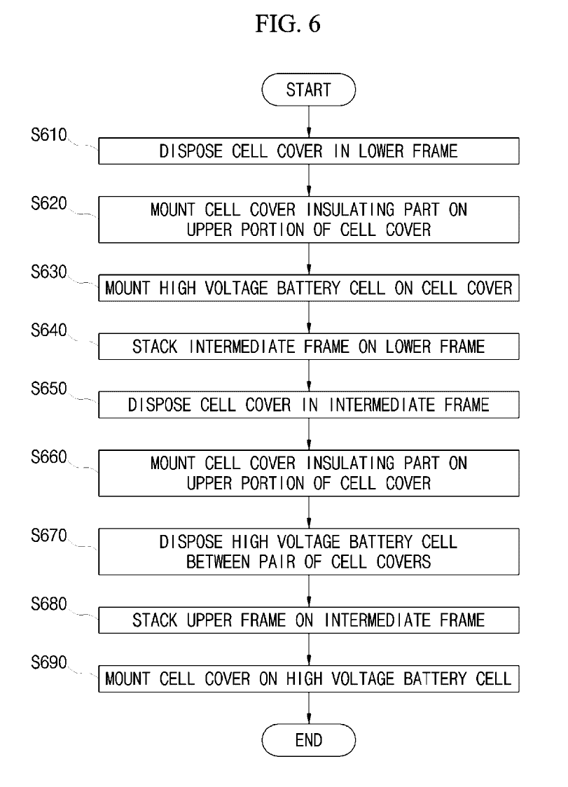

FIG. 6 is a flowchart illustrating a combining sequence of a high voltage battery submodule according to an embodiment of the present invention.

First, a single cell cover 500 is disposed in a lower frame 430 (S600).

In this case, the cell cover 500 is disposed so that a surface on which flow path protrusions 520 are formed faces downwards from a base plate 510.

Thus, a surface opposite to the surface on which the flow path protrusions 520 are formed may be disposed to be easily in area contact with a high voltage battery cell 100 based on the base plate 510.

Next, cell cover insulating portions 600 are mounted at positions, at which electrode tabs 200 are disposed, on an upper portion of the cell cover 500 (S620).

The cell cover insulating portions 600, which are formed of nonconductors, block the electrical connections between the cell covers 500 and the electrode tabs 200.

Further, a pair of high voltage battery cells 100 are mounted on a surface opposite to the surface of the cell cover 500 on which the flow path protrusions 520 are formed (S630).

Meanwhile, a high voltage battery cell 100 disposed in each of the upper frame 410, intermediate frames 420, and the lower frame 430 is provided with a first electrode tab 210 and a second electrode tab 220 extending from both edge surfaces thereof in a horizontal direction.

A first electrode tab 210 of a lower high voltage battery cell 100 of a pair of high voltage battery cells 100 disposed in the lower frame 430 is formed to have a linear cross sectional shape and is electrically connected to a busbar, and a first electrode tab 210 of a high voltage battery cell 100 disposed on top is formed to have a right angle cross sectional shape.

Further, the second electrode tab 220 is formed in a shape bent in multiple stages.

More specifically, the second electrode tab 220 includes a second cell extending portion 221 configured to extend from edge surfaces of the high voltage battery cell 100 in the horizontal direction, a second bent portion 222 bent from the second cell extending portion 221 in a vertical direction, a bent extending portion 223 configured to extend from the second bent portion 222 in the horizontal direction, and a bending force portion 224 formed between the second bent portion 221 and the bent extending portion 222.

The second electrode tab 220 is disposed in a shape in which the bent extending portion 223 of the lower high voltage battery cell 100 and the bent extending portion 223 of the upper high voltage battery cell 100, among the pair of the high voltage battery cells 100 disposed in the lower frame 430, are connected to be in area contact with each other.

Next, the intermediate frames 420 are stacked on the lower frame 430 in the vertical direction (S640).

Cell covers 500 are disposed in the intermediate frames 420 (S650).

Meanwhile, a pair of cell covers 500 are disposed in an intermediate frame 420 (S650).

The flow path protrusions 520 protruding from the base plates 510 of the pair of cell covers 500 are disposed to face each other.

Thus, cooling flow paths 530, in which a gas for cooling the high voltage battery cell 100 flows between the flow path protrusions 520 disposed to be spaced apart from each other, are formed in the intermediate frame 420.

Next, the cell cover insulating portions 600 are mounted at positions, at which the electrode tabs 200 are disposed, on the upper portion of the cell cover 500 (S660).

Further, high voltage battery cells 100 are disposed between pairs of cell covers 500 disposed in the intermediate frames 420 (S670).

First electrode tabs 210 of electrode tabs 200 of the high voltage battery cells 100 disposed in the intermediate frames 420 are formed to have a right angle cross sectional shape.

The first electrode tabs 210 having the right angle cross sectional shape are sequentially disposed from directly on an upper high voltage battery cell 100 of the pair of high voltage battery cells 100 disposed in the lower frame 430.

Therefore, a first bent portion 212 of a lower high voltage battery cell 100 of the pair of high voltage battery cells 100 disposed in the intermediate frame 420 is bent downward and in contact with a first bent portion 212 of the upper high voltage battery cell 100 of the pair of high voltage battery cells 100 disposed in the lower frame 430.

Further, the first bent portion 212 of the upper high voltage battery cell 100 of the pair of high voltage battery cells 100 disposed in the intermediate frame 420 is in contact with the first bent portion 212 of the high voltage battery cell 100 disposed directly on the high voltage battery cell 100.

Further, the second electrode tab 220 is disposed in a shape in which the bent extending portion 223 of the lower high voltage battery cells 100 and the bent extending portion 223 of the upper high voltage battery cells 100, among the pair of high voltage battery cells 100 disposed in the intermediate frame 420, are connected to be in area contact with each other.

The intermediate frames 420 are stacked variously in a number corresponding to a type of vehicle or a voltage required for the vehicle.

Next, an upper frame 410 is stacked on an uppermost intermediate frame 420 of the intermediate frames 420 stacked in multiple frames (S680).

A pair of high voltage battery cells 100 are disposed in the upper frame 410 (S680).

Here, a first electrode tab 210 of an upper high voltage battery cell 100 of a pair of high voltage battery cells 100 disposed in the upper frame 410 is formed to have a linear cross sectional shape and is connected to a busbar.

Further, a first electrode tab 210 of a lower high voltage battery cell 100 of the pair of high voltage battery cells 100 disposed in the upper frame 410 is formed to have a right angle cross sectional shape, and a first bent portion 212 is in area contact with a first bent portion 212 of a uppermost high voltage battery cell 100 disposed in the intermediate frame 420.

Next, a single cell cover 500 is mounted on the upper high voltage battery cell 100 of the pair of high voltage battery cells 100 disposed in the upper frame 410 (S690).

In this case, the cell cover 500 is disposed so that a surface on which flow path protrusions 520 are formed faces upwards from a base plate 510.

Thus, a surface opposite to the surface on which the flow path protrusions 520 are formed based on the base plate 510 may be disposed to be easily in area contact with a high voltage battery cell 100.

Meanwhile, cell cover insulating portions 600 are disposed between the electrode tabs 200 and the cell cover 500.

The cell cover insulating portions 600, which are formed of nonconductors, block electrical connections between the cell cover 500 and the electrode tabs 200.

Therefore, when the high voltage battery cells 100 of the present embodiment are installed to be stacked inside the frames 400, the high voltage battery cells 100 are stacked to be connected to each other in a zigzag form so as to have a structure in which the first electrode tab 210 of the lower high voltage battery cell 100 and the first electrode tab 210 of the upper high voltage battery cell 100, among the pair of high voltage battery cells 100 disposed in the frame 400, are connected to each other.

As described above, in the high voltage battery submodule according to the present invention, since the sensing terminal protrusions 310 are formed on the voltage sensing terminal 300, the voltage sensing terminals 300 and the bent extending portion 223 are firmly pressed into each other, and a contact failure may be prevented from occurring between the bent extending portion 223 and the voltage sensing terminals 300 even during repeated expansion and contraction of the high voltage battery cells 100 while charging or discharging the battery submodule.

Further, since the electrode tabs 200 and the voltage sensing terminals 300 are physically in contact with each other, an assembly time of the high voltage battery submodule may be effectively reduced.

Further, since the cell covers 500 are disposed on the high voltage battery cells 100 disposed in the upper frame 410 and the lower frame 430, the cell cover 500 disposed at the upper portion of the upper frame 410 may protect the high voltage battery cells 100 disposed in the upper frame 410 from external force.

Further, since the cell covers 500 disposed in the intermediate frame 420, in which the flow path protrusions 520 protruding from the base plates 510 face each other, are disposed as a pair, the cooling flow paths 530, in which a gas for cooling the high voltage battery cells 100 flows between the flow path protrusions 520 disposed to be spaced apart from each other, are formed in the intermediate frame 420, the gas flows to the cooling flow paths 530 formed in the cell cover 500, and thus heat generated from the high voltage battery cells 100 may be effectively cooled.

In the high voltage battery submodule according to the present invention, since sensing terminal protrusions are formed on a voltage sensing terminal, the voltage sensing terminal and a bent extending portion are firmly pressed into each other. Therefore, it is possible to prevent a contact failure from occurring between the bent extending portion and the voltage sensing terminal even during repeated expansion and contraction of the high voltage battery cells while charging or discharging the battery submodule.

Further, since an electrode tab and the voltage sensing terminal are physically in contact with each other, it is possible to reduce effectively an assembly time of the high voltage battery submodule.

Further, since cell covers are disposed on the high voltage battery cells which are disposed in an upper frame and a lower frame, it is possible for the cell cover disposed on the upper frame to protect the high voltage battery cells disposed in the upper frame from external force.

Further, since cell covers disposed in intermediate frames, in which flow path protrusions protruding from base plates face each other, are disposed as a pair, flow paths in which a gas for cooling the high voltage battery cells flows are formed between the flow path protrusions which are disposed to be spaced apart from each other in an intermediate frame. Therefore, it is possible to cool effectively heat generated from the high voltage battery cells by flowing the gas to the flow paths formed on the cell covers.

Therefore, the invention is not limited to the above-described embodiments and various changes may be made without departing from the spirit and scope of the appended claims.

What is claimed is:

1. A high voltage battery submodule installed in a high voltage battery system, the submodule comprising:
a plurality of high voltage battery cells configured to store power to be supplied to the high voltage battery system, stacked in a vertical direction to be in area contact with each other, and having electrode tabs extended from both sides among edge surfaces thereof in a horizontal direction;
a frame formed in a rectangular ring shape to be in close contact with the edge surfaces of the high voltage battery cells and having electrode tab mounting grooves in which the electrode tabs are mountable at positions corresponding to the electrode tabs, formed in an inner side surface; and
a cell cover disposed on or under a pair of high voltage battery cells which are in area contact with each other in the frame,
wherein the frame includes:
an upper frame configured to accommodate a pair of high voltage battery cells therein;
a plurality of intermediate frames disposed under the upper frame and configured to accommodate a pair of high voltage battery cells therein; and
a lower frame disposed under a lowermost intermediate frame and configured to accommodate a pair of high voltage battery cells, and
the cell cover is disposed on only any one of an upper side or a lower side of each of the plurality of high voltage battery cells in the frame.

2. The submodule of claim 1, wherein the cell cover includes:
a base plate disposed on an upper surface or a lower surface of the high voltage battery cell; and
a plurality of flow path protrusions formed on the base plate, spaced apart from each other in the horizontal direction, and configured to protrude in the vertical direction.

3. The submodule of claim 2, wherein cell covers disposed in the intermediate frames, in which flow path protrusions configured to protrude from base plates face each other, are disposed as a pair so that a flow path in which a gas for cooling the high voltage battery cells flows is formed between the flow path protrusions disposed to be spaced apart from each other.

4. The submodule of claim 1, wherein flow path holes in which a gas for cooling heat generated from the high voltage battery cell flows are formed in both side surfaces of the intermediate frames along a longitudinal direction.

5. The submodule of claim 1, wherein each of the electrode tabs includes:
a first electrode tab including a first cell extending portion configured to extend from an edge surface of the high voltage battery cell in the horizontal direction and a first bent portion bent from the first cell extending portion in the vertical direction; and
a second electrode tab including a second cell extending portion configured to extend from a surface in an opposite direction to the first electrode tab, among the edge surfaces of the high voltage battery cell, in the horizontal direction, a second bent portion bent from the second cell extending portion in the vertical direction, and a bent extending portion configured to extend from the second bent portion in the horizontal direction, and
the second electrode tabs of the electrode tabs are symmetrically disposed in the vertical direction based on the horizontal direction between the pair of high voltage battery cells so that the bent extending portions of the second electrode tabs extend respectively from the edges surfaces of the pair of high voltage battery cells which are in area contact with each other and are in area contact with each other.

6. The submodule of claim 5, wherein the electrode tab mounting grooves include:
a first mounting groove formed at a position corresponding to the first electrode tab in edges of each of the upper frame, the intermediate frames, and the lower frame to have the same width as the first electrode tab, in which the first electrode tab is mounted, opened to be in communication with the outside, and configured to expose the first bent portion to the outside; and
a second mounting groove including a bent supporting portion configured to protrude from a bottom surface of each of the intermediate frames and the lower frame in the vertical direction on the opposite edges of each of the intermediate frames and the lower frame to the first mounting groove and to support the second bent portion, a bent extending and mounting portion configured to extend from the bent supporting portion in the horizontal direction and in which the bent extending portion is mounted, and a sealing portion configured to protrude from the bent extending and mounting portion in the vertical direction and to seal the second electrode tab.

7. The submodule of claim 6, wherein a voltage sensing terminal configured to sense a voltage of the high voltage battery cell is disposed on a lower surface of the bent extending portion.

8. The submodule of claim 7, wherein a plurality of sensing terminal protrusions are formed on an upper surface of the voltage sensing terminal to be pressed into the lower surface of the bent extending portion.

9. The submodule of claim 6, wherein an electrode tab pressing protrusion is formed at a position corresponding to the second mounting groove on a lower surface of each of the upper frame and the intermediate frames to have the same width as the second mounting groove, and protrudes so that a lower surface of the bent extending portion and the voltage sensing terminal are pressed into each other by pressing the bent extending portion.

10. The submodule of claim 6, wherein, when the plurality of high voltage battery cells are stacked in the frame, a bending force portion is formed between the second cell extending portion and the second bent portion so that the electrically connected bent extending portions are pressed into each other by applying an elastic force in a direction in which the electrically connected bent extending portions face each other.

11. The submodule of claim 6, wherein, when the plurality of high voltage battery cells are installed to be stacked in the upper frame, the intermediate frames, and the lower frame, the first electrode tabs of the electrode tabs are connected in a zigzag form so as to have a structure in which a lowermost first electrode tab and an uppermost first electrode tab are connected to each other.
